(19) United States
(12) Patent Application Publication
(10) Pub. No.: US 2015/0271233 A1
(43) Pub. Date: Sep. 24, 2015

(54) METHOD AND APPARATUS FOR DASH STREAMING USING HTTP STREAMING

(71) Applicant: SAMSUNG ELECTRONICS CO., LTD., Suwon-si (KR)

(72) Inventor: Imed Bouazizi, Plano, TX (US)

(21) Appl. No.: 14/661,668

(22) Filed: Mar. 18, 2015

Related U.S. Application Data
(60) Provisional application No. 61/968,204, filed on Mar. 20, 2014.

(51) Int. Cl. H04L 29/06; H04L 12/26; H04L 29/08

(52) U.S. Cl. CPC H04L 65/60; H04L 67/02; H04L 43/0852

(57) ABSTRACT

A client device communicates with a server to receive media streaming. The client device is able to determine whether the server supports adaptive hypertext transfer protocol (HTTP) streaming over a WebSocket. For example, the server can send an indication to the at least one client device that adaptive HTTP streaming over a WebSocket is supported. The client device is sends commands to the server to perform rate adaptation operations during the HTTP streaming. In response, the server includes establishes an incoming WebSocket connection with the client device in response to a command received from the client device to perform rate adaptation operations during the HTTP streaming. The client device continues to receive media segments until a triggering event occurs.

### CROSS-REFERENCE TO RELATED APPLICATION(S) AND CLAIM OF PRIORITY

The present application claims priority to U.S. Provisional Patent Application Ser. No. 61/968,204 filed Mar. 20, 2014, entitled “METHOD AND APPARATUS FOR DASH STREAMING USING HTTP STREAMING”. The content of the above-identified patent document is incorporated herein by reference.

### TECHNICAL FIELD

The present application relates generally to media data delivery in a transmission system and, more specifically, to push-based adaptive Hypertext Transport Protocol (HTTP) streaming.

### BACKGROUND

Traditionally, the Transmission Control Protocol (TCP) has been considered as not suitable for the delivery of real-time media such as audio and video content. This is mainly due to the aggressive congestion control algorithm and the retransmission procedure that TCP implements. In TCP, the sender reduces the transmission rate significantly (typically by half) upon detection of a congestion event, typically recognized through packet loss or excessive transmission delays. As a consequence, the transmission throughput of TCP is usually characterized by the well-known saw-tooth shape. This behavior is detrimental for streaming applications as they are delay-sensitive but relatively loss-tolerant, whereas TCP sacrifices delivery delay in favor of reliable and congestion-aware transmission.

Recently, the trend has shifted towards the deployment of the Hypertext Transport Protocol (HTTP) as the preferred protocol for the delivery of multimedia content over the Internet. HTTP runs on top of TCP and is a textual protocol. The reason for this shift is attributable to the ease of deployment of the protocol. There is no need to deploy a dedicated server for delivering the content. Furthermore, HTTP is typically granted access through firewalls and NATs, which significantly simplifies the deployment.

### SUMMARY

In a first embodiment, a device is provided. The device includes: an antenna configured to establish a communication connection with a server. The device also includes processing circuitry configured to: determine a capability of the server to support adaptive hypertext transfer protocol (HTTP) streaming over a WebSocket; send commands to the server to perform rate adaptation operations during the HTTP streaming; and receive information from the server on the HTTP streaming.

In a second embodiment, a server is provided. The server includes an interface configured to couple to at least one client device. The server also includes processing circuitry configured to: send an indication to the at least one client device that adaptive hypertext transfer protocol (HTTP) streaming over a WebSocket is supported; receive a request to upgrade, determine whether to accept or deny the upgrade, and establish an incoming WebSocket connection with the at least one client device in response to a command received from the at least one client device to streaming operations during the HTTP streaming.

In a third embodiment, a method for a client device is provided. The method includes establishing a communication connection with a server. The method also includes determining a capability of the server to support adaptive hypertext transfer protocol (HTTP) streaming over a WebSocket. The method further includes sending commands to the server to perform streaming operations during the HTTP streaming.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example computing system according to this disclosure;

FIGS. 2 and 3 illustrate example devices in a computing system according to this disclosure;

FIG. 4 illustrates adaptive HTTP Streaming Architecture according to embodiments of the present disclosure;

FIG. 5 illustrates an MPD structure according to embodiments of the present disclosure;

FIGS. 6 and 7 illustrate differences between HTTP 1.0 and HTTP 1.1 according to this disclosure;

FIG. 8 illustrates a WebSocket supported network according to embodiments of the present disclosure;

FIG. 9 illustrates an adaptive HTTP streaming process utilizing WebSocket for a client device according to embodiments of the present disclosure; and

FIG. 10 illustrates an adaptive HTTP streaming process utilizing WebSocket for a server according to embodiments of the present disclosure.

### DETAILED DESCRIPTION

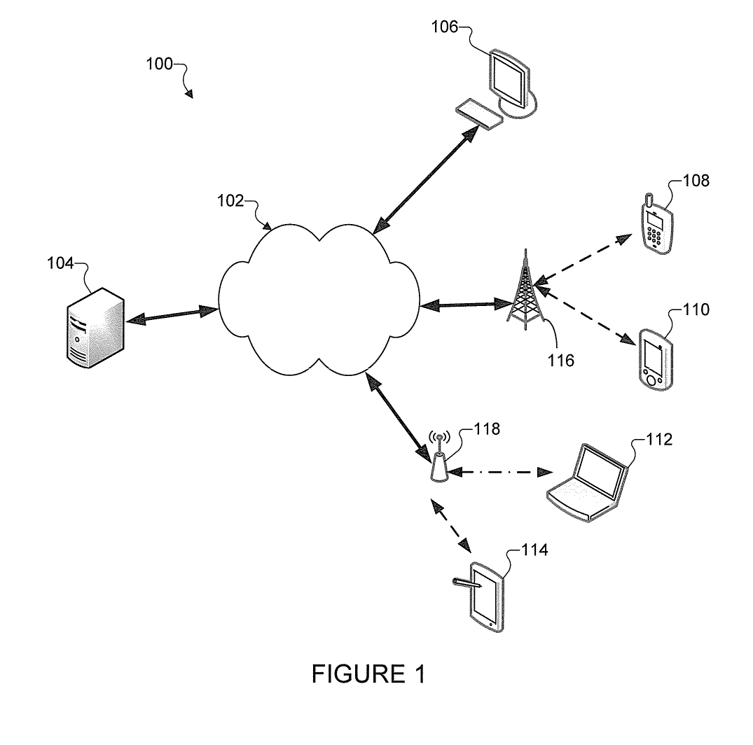

FIGS. 1 through 10, discussed below, and the various embodiments used to describe the principles of the present invention in this patent document are by way of illustration only and should not be construed in any way to limit the scope of the disclosure. Those skilled in the art will understand that the principles of this disclosure may be implemented in any suitably arranged device or system.

FIG. 1 illustrates an example computing system 100 according to this disclosure. The embodiment of the computing system 100 shown in FIG. 1 is for illustration only. Other embodiments of the computing system 100 could be used without departing from the scope of this disclosure.

As shown in FIG. 1, the system 100 includes a network 102, which facilitates communication between various components in the system 100. For example, the network 102 may communicate Internet Protocol (IP) packets, frame relay frames, Asynchronous Transfer Mode (ATM) cells, or other information between network addresses. The network 102 may include one or more local area networks (LANs), metropolitan area networks (MANs), wide area networks (WANs), all or a portion of a global network such as the Internet, or any other communication system or systems at one or more locations.

The network 102 facilitates communications between at least one server 104 and various client devices 106-114. Each server 104 includes any suitable computing or processing device that can provide computing services for one or more client devices. Each server 104 could, for example, include one or more processing devices, one or more memories storing instructions and data, and one or more network interfaces facilitating communication over the network 102.

Each client device 106-114 represents any suitable computing or processing device that interacts with at least one server or other computing device(s) over the network 102. In this example, the client devices 106-114 include a desktop computer 106, a mobile telephone or smartphone 108, a personal digital assistant (PDA) 110, a laptop computer 112, and a tablet computer 114. However, any other or additional client devices could be used in the computing system 100.

In this example, some client devices 108-114 communicate indirectly with the network 102. For example, the client devices 108-110 communicate via one or more base stations 116, such as cellular base stations or eNodeBs. Also, the client devices 112-114 communicate via one or more wireless access points 118, such as IEEE 802.11 wireless access points. Note that these are for illustration only and that each client device could communicate directly with the network 102 or indirectly with the network 102 via any suitable intermediate device(s) or network(s).

As described in more detail below, network 102 facilitates efficient push-based media streaming over HTTP. One or more servers 104 supports media streaming over WebSocket. One or more client devices 106-114 are able to detect when the server 104 support media streaming over WebSockets. When the server 104 supports media streaming over WebSockets, one or more client devices 106-114 is able to establish a WebSocket connection to the server and submit the initial request indicating the selected representation and the position in the stream. The respective client devices 106-114 then receives media segments sequentially as they are pushed by the server 104.

Although FIG. 1 illustrates one example of a computing system 100, various changes may be made to FIG. 1. For example, the system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

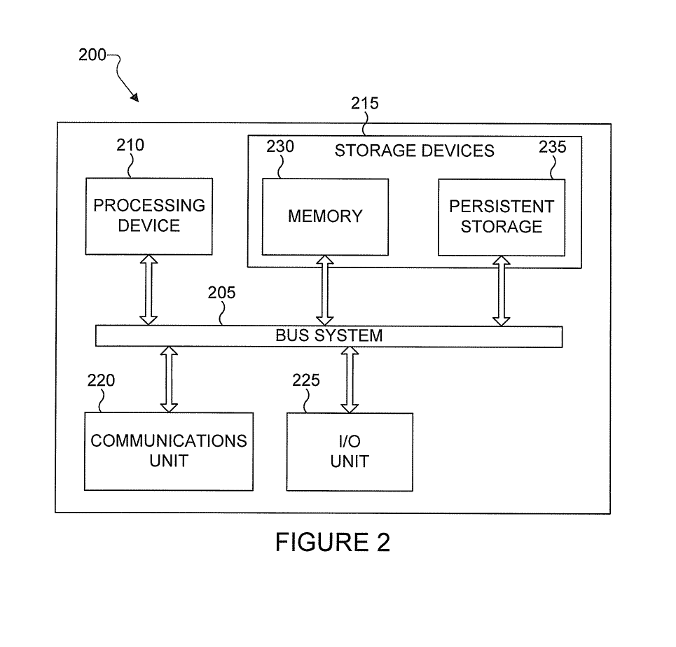

FIGS. 2 and 3 illustrate example devices in a computing system according to this disclosure. In particular, FIG. 2 illustrates an example server 200, and FIG. 3 illustrates an example client device 300. The server 200 could represent the server 104 in FIG. 1, and the client device 300 could represent one or more of the client devices 106-114 in FIG. 1.

As shown in FIG. 2, the server 200 includes a bus system 205, which supports communication between at least one processing device 210, at least one storage device 215, at least one communications unit 220, and at least one input/output (I/O) unit 225. The server 104 can be configured the same as, or similar to server 200. The server 200 is capable of supporting media streaming over WebSocket.

The processing device 210 executes instructions that may be loaded into a memory 230. The processing device 210 may include any suitable number(s) and type(s) of processors or other devices in any suitable arrangement. Example types of processing devices 210 include microprocessors, microcontrollers, digital signal processors, field programmable gate arrays, application specific integrated circuits, and discreet circuitry.

The memory 230 and a persistent storage 235 are examples of storage devices 215, which represent any structure(s) capable of storing and facilitating retrieval of information (such as data, program code, and/or other suitable information on a temporary or permanent basis). The memory 230 may represent a random access memory or any other suitable volatile or non-volatile storage device(s). The persistent storage 235 may contain one or more components or devices supporting longer-term storage of data, such as a ready only memory, hard drive, Flash memory, or optical disc.

The communications unit 220 supports communications with other systems or devices. For example, the communications unit 220 could include processing circuitry, a network interface card or a wireless transceiver facilitating communications over the network 102. The communications unit 220 may support communications through any suitable physical or wireless communication link(s). The communications unit 220 enables connection to one or more client devices. That is, the communications unit 220 provides an interface configured to couple to at least one client device.

The I/O unit 225 allows for input and output of data. For example, the I/O unit 225 may provide a connection for user input through a keyboard, mouse, keypad, touchscreen, or other suitable input device. The I/O unit 225 may also send output to a display, printer, or other suitable output device.

Note that while FIG. 2 is described as representing the server 104 of FIG. 1, the same or similar structure could be used in one or more of the client devices 106-114. For example, a laptop or desktop computer could have the same or similar structure as that shown in FIG. 2.

FIG. 3 illustrates an example STA 300 according to this disclosure. The embodiment of the STA 300 illustrated in FIG. 2 is for illustration only, and the STAs 104-112 of FIG. 1 could have the same or similar configuration. However, STAs come in a wide variety of configurations, and FIG. 3 does not limit the scope of this disclosure to any particular implementation of a STA.

The STA 300 includes multiple antennas 305a-305n, multiple radio frequency (RF) transceivers 310a-310n, transmit (TX) processing circuitry 315, a microphone 320, and receive (RX) processing circuitry 325. The TX processing circuitry 315 and RX processing circuitry 325 are respectively coupled to each of the RF transceivers 310a-310n, for example, coupled to RF transceiver 310a, RF transceiver 2310b through to a N^{th} RF transceiver 310n, which are coupled respectively to antenna 305a, antenna 305b and an N^{th} antenna 305n. In certain embodiments, the STA 104 includes a single antenna 305a and a single RF transceiver 310a. The STA 300 also includes a speaker 330, a main processor 340, an input/output (I/O) interface (IF) 345, a keypad 350, a display 355, and a memory 360. The memory 260 includes a basic operating system (OS) program 261 and one or more applications 262.

The RF transceivers 310a-310n receive, from respective antennas 305a-305n, an incoming RF signal transmitted by an AP 102 of the network 100. The RF transceivers 310a-310n down-convert the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceivers 310a-310n receive the outgoing processed baseband or IF signal from the TX processing circuitry 315 and up-converts the baseband or IF signal to an RF signal that is transmitted via one or more of the antennas 305a-305n.

The main processor 340 can include one or more processors or other processing devices and execute the basic OS program 361 stored in the memory 360 in order to control the overall operation of the STA 300. For example, the main processor 340 could control the reception of forward channel signals and the transmission of reverse channel signals by the RF transceivers 310a-310n, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360, such as operations for media streaming over WebSockets. The main processor 340 can move data into or out of the memory 360 as required by an executing process. In some embodiments, the main processor 340 is configured to execute the applications 362 based on the OS program 361 or in response to signals received from AP 102 or an operator. The main processor 340 is also coupled to the I/O interface 345, which provides the STA 300 with the ability to connect to other devices such as laptop computers and handheld computers. The I/O interface 345 is the communication path between these accessories and the main controller 340.

The main processor 340 is also coupled to the keypad 350 and the display unit 355. The operator of the STA 300 can use the keypad 350 to enter data into the STA 300. The display 355 may be a liquid crystal display or other display capable of rendering text and/or at least limited graphics, such as from web sites.

The memory 360 is coupled to the main processor 340. Part of the memory 360 could include a random access memory (RAM), and another part of the memory 360 could include a Flash memory or other read-only memory (ROM).

Although FIGS. 2 and 3 illustrate examples of devices in a computing system, various changes may be made to FIGS. 2 and 3. For example, various components in FIGS. 2 and 3 could be combined, further subdivided, or omitted and additional components could be added according to particular needs. As a particular example, the main processor 340 could be divided into multiple processors, such as one or more central processing units (CPUs) and one or more graphics processing units (GPUs). Also, while FIG. 3 illustrates the client device 300 configured as a mobile telephone or smartphone, client devices could be configured to operate as other types of mobile or stationary devices. In addition, as with computing and communication networks, client devices and servers can come in a wide variety of configurations, and FIGS. 2 and 3 do not limit this disclosure to any particular client device or server.

Dynamic Adaptive Streaming over HTTP (DASH) has been standardized recently by 3GPP and MPEG. Several other proprietary solutions for adaptive HTTP Streaming such HTTP Live Streaming (HLS) by APPLE® and Smooth Streaming by MICROSOFT® are being commercially deployed nowadays. In contrast, DASH is a fully open and standardized media streaming solution, which drives inter-operability among different implementations.

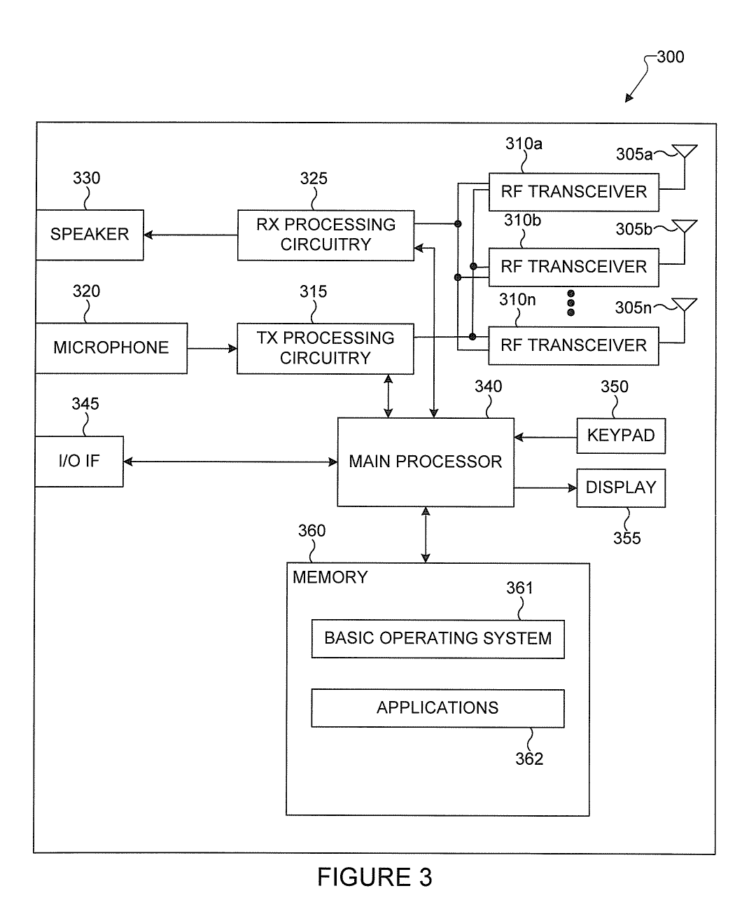

FIG. 4 illustrates adaptive HTTP Streaming Architecture according to embodiments of the present disclosure. The embodiment of the HTTP Streaming Architecture 400 shown in FIG. 4 is for illustration only. Other embodiments could be used without departing from the scope of the present disclosure.

In the HTTP Streaming Architecture 400, content is prepared in a content preparation 405 step. The content is delivered by an HTTP streaming server 410. The HTTP streaming server 410 can be configured the same as, or similar to, the server 104. In streaming, the content is cached, or buffered, in HTTP cached 415 and further streamed to HTTP streaming client 420. The HTTP streaming client 420 can be one of the clients 106-114.

In DASH, a content preparation 405 step needs to be performed, in which the content is segmented into multiple segments. An initialization segment is created to carry the information necessary to configure the media player. Only then can media segments be consumed. The content is typically encoded in multiple variants, typically several bitrates. Each variant corresponds to a Representation of the content. The content representations can be alternative to each other or they may complement each other. In the former case, the client selects only one alternative out of the group of alternative representations. Alternative Representations are grouped together as an adaptation set. The client can continue to add complementary representations that contain additional media components.

The content offered for DASH streaming needs to be described to the client 420. This is done using a Media Presentation Description (MPD) file. The MPD is an XML file that contains a description of the content, the periods of the content, the adaptation sets, the representations of the content and most importantly, how to access each piece of the content. The MPD element is the main element in the MPD file. It contains general information about the content, such as its type and the time window during which the content is available. The MPD contains one or more Periods, each of which describes a time segment of the content. Each Period can contain one or more representations of the content grouped into one or more adaptation sets. Each representation is an encoding of the one or more content components and with a specific configuration. Representations differ mainly in their bandwidth requirements, the media components they contain, the codecs in use, the languages, and so forth.

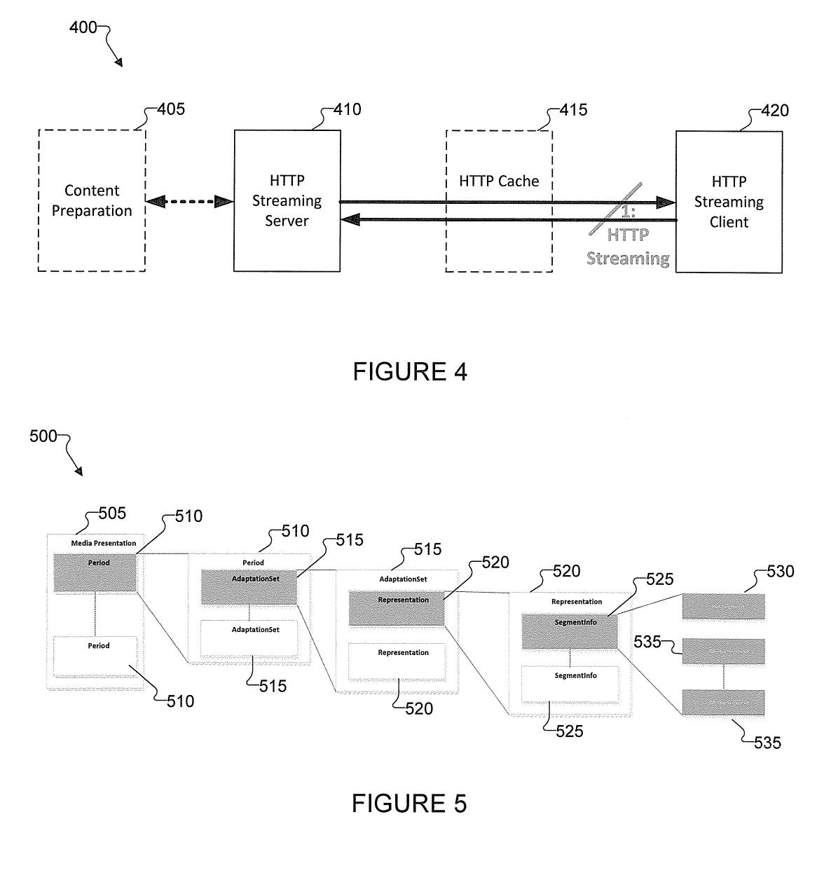

FIG. 5 illustrates an MPD structure according to embodiments of the present disclosure. The embodiment of the MPD structure 500 shown in FIG. 5 is for illustration only. Other embodiments could be used without departing from the scope of the present disclosure.

In the example shown in FIG. 5, the MPD structure 500 includes a media presentation 505 that has a number of periods 510. Each period 510 includes a number of adaptation sets 515. Each adaptation set 515 includes a number of representations 520. Each representation 520 includes segment information 525. The segment information 525 includes an initial segment 530 and a number of media segments 535.

In one deployment scenario of DASH, the ISO-base File Format and its derivatives (the MP4 and the 3GP file formats) are used. The content is stored in so-called movie fragments. Each movie fragment contains the media data and the corresponding meta data. The media data is typically a collection of media samples from all media components of the representation. Each media component is described as a track of the file.

HTTP Streaming

HTTP is a request/response based protocol. A client device 300 establishes a connection to a server 200 to send its HTTP requests. The server 200 accepts connections from the client devices 300 to receive the HTTP requests and send back the responses to the client device 300. In the standard HTTP model, a server 200 cannot initiate a connection to the client nor send unrequested HTTP responses. In order to perform media streaming over HTTP, a client device 300 has then to request the media data segment 505 by segment 505. This generates a significant upstream traffic for the requests as well as additional end-to-end delays.

In order to improve the situation for web applications, several so-called HTTP streaming mechanisms have been developed by the community. These mechanisms enable the web server 200 to send data to the client devices 300 without waiting for a poll request from the client devices 300. The main approaches for HTTP streaming (denoted usually as COMET) are by either keeping the request on hold until data becomes available or by keeping the response open indefinitely. In the first case, a new request will still need to be sent after a response has been received. In HTTP streaming, the request is not terminated and the connection is not closed. Data is then pushed to the client device 300 whenever the data becomes available.

HTTP Long Polling

With the traditional requests, a client sends a regular request to the server 200 and each request attempts to pull any available data. If there is no data available, the server 200 returns an empty response or an error messages. The client device 300 performs a poll at a later time. The polling frequency depends on the application. In DASH, this is determined by the segment availability start time, but requires clock synchronization between client and server.

In long polling, the server 200 attempts to minimize the latency and the polling frequency by keeping request on hold until the requested resource becomes available. When applied to DASH, no response will be sent until the requested DASH segment becomes available. In contrast, the current default behavior is that a request for a segment that is not available will be a “404 error” response.

However, long polling might not be optimal for DASH as the client device 300 will still have to send an HTTP request for every segment. It is also likely that the segment URL is not known a-priori, so that the client device 300 will have to first get the MPD and parse it to find out the location of the current segment, which incurs additional delays.

HTTP Streaming

The HTTP streaming mechanism keeps a request open indefinitely. It does not terminate the request or close the connection even after some data has been sent to the client. This mechanism significantly reduces the latency because the client and the server do not need to open and close the connection. The procedure starts by the client device 300 making an initial request. The client device 300 then waits for a response. The server 200 defers the response until data is available. Whenever data is available the server will send the data back to the client device 300 as a partial response. This is a capability that is supported by both HTTP/1.1 and HTTP/1.0. In this case, the Content-Length header field is not provided in the response as it is unknown a-priori. Instead the response length will be determined through closing of the connection. The main issue with this HTTP streaming approach is that the behavior of intermediate nodes with regards to such connections cannot be guaranteed. For example, an intermedia node may not forward a partial response immediately. The intermedia node can decide to buffer the response and send it at a later time.

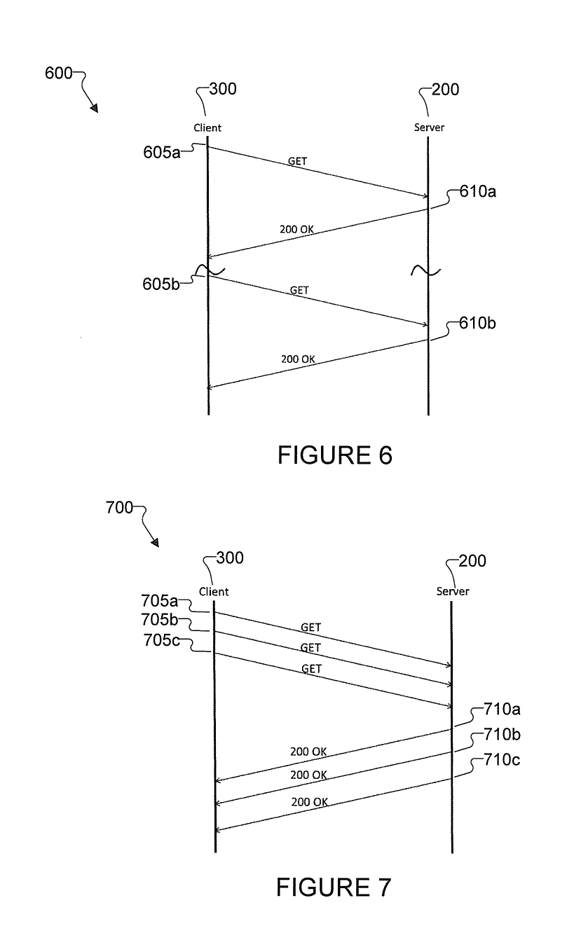

FIGS. 6 and 7 illustrate differences between HTTP 1.0 and HTTP 1.1 according to this disclosure. While the flow charts depict a series of sequential signals, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by processing circuitry, for example, in a server or in a client device.

HTTP/2 and WebSocket

The need for more flexibility in the HTTP protocol has been identified early enough but the community has been reluctant to make changes to one of the most popular and heavily used protocols. The example shown in FIG. 6 illustrates that HTTP 1.0 600 allows for only one request per connection, resulting in significant delays for ramping up and down the TCP connection. For each “get” request by the client device 300, a successive response is sent by the server 200. That is, for a first “get” request 605a by the client device 300, a successive response 610a is sent by the server 200. For a second “get” request 605b by the client device 300, a successive response 610b is sent by the server 200. The example shown in FIG. 7 illustrates that HTTP 1.1 700 introduces persistent connections and request pipelining. Multiple “get” requests by the client device 300 are followed by multiple respective responses sent by the server 200. That is, for a first “get” request 705a, a second “get” request 705b and a third “get” request 705c are sent by the client device 300. In response, a respective first response 710a, second response 710b and third response 710c are sent by the server 200. With persistent connections, the same TCP connection can be used to issue multiple requests and receive their responses. This avoids going through the connection setup and slow-start phases of TCP. Request pipelining allows the client to send multiple requests prior to receiving the responses on prior requests. The examples shown in FIGS. 6 and 7 illustrate the different message exchange sequences for HTTP 1.0 and HTTP 1.1, showing the potential gains in terms of delay and link utilization.

However, HTTP 1.1 700 does not fulfill all application needs with the introduction of pipelining and persistent connections. For example, even when using pipelining, responses from the server 200 must be in the same order as the client device 300 requests and if one request blocks, the following requests will also block. That is, is the first “get” request 705a blocks, then the second “get” request 705b and third “get” request 705c also block. HTTP 1.1 700 does not support pushing of content from the server 200 to the client device 300 either. The client device 300 will thus only get resources that the client device 300 has actually requested. For regular web sites, it is highly likely that a set of linked resources will be requested after requesting the main HTML document that links all of them. Consequently, the client device 300 must wait for the main file to be received and parsed before it requests the linked resources, which can incur significant delay in rendering the web site.

In the following embodiments, new features provided by HTTP/2 and WebSocket are disclosed. Certain embodiments of the present disclosure enable DASH over HTTP/2 and WebSocket.

HTTP 2.0

HTTP 2.0, herein also referred to as “HTTP/2”, is a working draft at the Internet Engineering Task Force (IETF) that intends to address the previous restrictions of HTTP 1.1 while at the same time keeping all functionality unchanged.

HTTP/2 introduces the concept of streams that are independently treated by the client device 300 and server 200. A stream is used to carry a request and to receive a response on that request, after which the stream is closed. The message exchange is done in frames, where a frame may be of type HEADERS or DATA, depending on what the payload of the frame is. In addition, a set of control frames are also defined. Those frames are used to cancel an ongoing stream (RST_STREAM), indicate stream priority compared to other streams (PRIORITY), communicate stream settings (SETTNGS), indicate that no more streams can be created on the current TCP connection (GOAWAY), perform a ping/pong operation (PING and PONG), provide a promise to push data from server to client (PUSH_PROMISE), or a continuation of a previous frame (CONTINUATION). In certain embodiments, a frame is at most 16383 bytes of length.

HTTP/2 also attempts to improve the over the wire efficiency through header compression. When used, header compression indexes header field names and uses a numerical identifier to indicate which header field is used. Most header fields are assigned a static id value, but header compression allows for assigning values to other header fields dynamically.

WebSocket

Similar to HTTP/2, in certain embodiments, WebSocket is also implemented as a fully conformant HTTP protocol upgrade, which starts with a handshake procedure, during which both ends agree on upgrading the connection to WebSocket. After a successful upgrade of the connection to a WebSocket connection, the data can flow in both directions simultaneously, resulting in a full duplex connection. The server 200 can decide to send data to the client device 300 without the need for a client request. The client device 300 also can send multiple requests without needing to wait for server responses.

In fact, HTTP/2 borrows a lot of the concepts from WebSocket, such as the handshake procedure and the framing procedure, including several frame types (such as data, continuation, ping, and pong). WebSocket does not define any further details about the format of the application data and leaves that to the application. The actual format is negotiated during the handshake phase, where both endpoints agree on a subprotocol to be used by exchanging the Sec-WebSocket-Protocol header field.

According to certain embodiments of the present disclosure:

(a) The client device 300 avoids pulling data continuously;

(b) The client device 300 avoids synchronization issues and resource fetch errors;

(c) The client device 300 is still in control of the session; and

(d) The server 200 gains some control over the session.

As a result, certain embodiments of the present disclosure reduce experience delays and network traffic.

In certain embodiments, a framing protocol is defined to enable push-based adaptive HTTP streaming over HTTP streaming solutions. The framing protocol enables client devices 300 to send commands to the server 300 to perform rate adaptation operations during the streaming session.

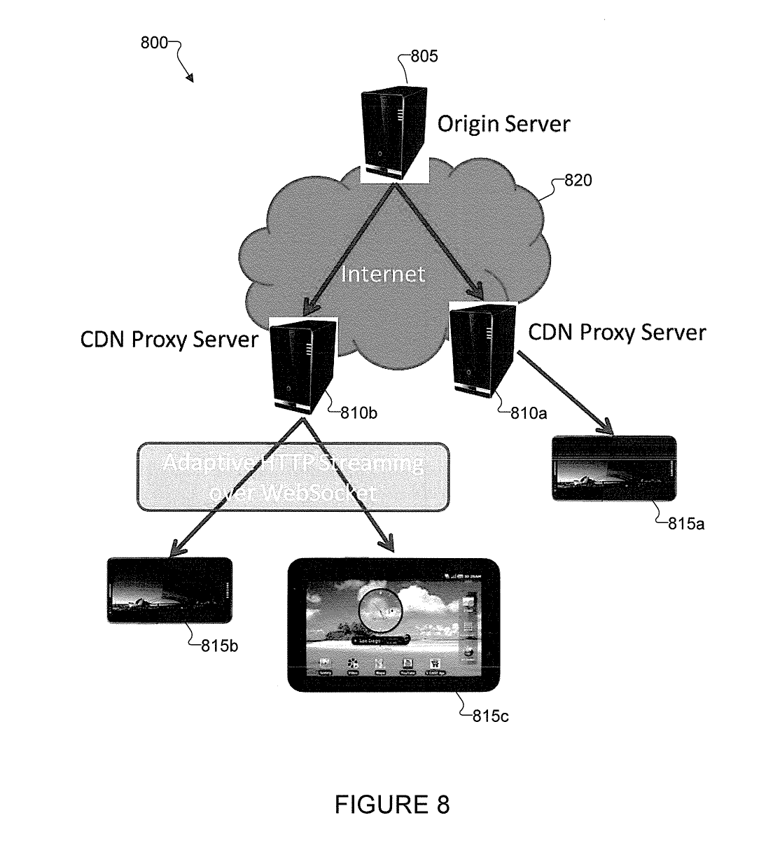

FIG. 8 illustrates a WebSocket supported network according to embodiments of the present disclosure. The embodiment of the WebSocket supported network 800 shown in FIG. 8 is for illustration only. Other embodiments could be used without departing from the scope of the present disclosure.

The WebSocket supported network 800 includes an origin server 805, one or more content delivery network (CDN) proxy servers 810, and a number of client devices 815. The origin server 805 can be configured the same as, or similar to, server 200. One or more CDN proxy servers 810 can be configured the same as, or similar to, server 200. One or more of the client devices 815 can be configured the same as, or similar to, client device 300. The CDN proxy servers 810 communicate with the origin server 805 via the internet 820. The internet 820 can be the same as, or similar to, network 102. The client device 815a establishes a communication connection with CDN Proxy server 810a, through which the client device 815a can receive content from the origin server 805. The client device 815b establishes a communication connection with CDN Proxy server 810b, through which the client device 815b can receive content from the origin server 805. The client device 815c establishes a communication connection with CDN Proxy server 810b, through which the client device 815c can receive content from the origin server 805. In the example shown in FIG. 8, WebSocket is used in the last hop to stream content to the clients from the CDN. That is, the client device 815b, or client device 815c, or both, establish an adaptive HTTP streaming over WebSocket 825 via respective connections through the CDN proxy server 815b to the origin server 805.

In certain embodiments, the client device 815b first detects if the origin server 805, or the CDN proxy server 810b supports media streaming over WebSockets. Although the embodiments illustrated with respect to, or including additionally, the client device 815b, embodiments corresponding with streaming to the client device 815c or client device 815a could be used without departing from the scope of the present disclosure. When the first device determines that either the origin server 805, or the CDN proxy server 810b, the client device 815b establishes a WebSocket connection to the origin server 805 via the CDN proxy server 810b and submits the initial request indicating the selected representation and the position in the stream. The client device 815b then receives media segments sequentially as the media segments are pushed by the origin server 805. This process continues until the client device 815b:

(a) Decides to select or switch to an alternative Representation;

(b) Decides to perform trick mode operations;

(c) Receives a manifest file update or an indication thereof that requires client action;

(d) Receives an end of stream or end of service indication; and

(e) Receives a request from the server to send a request for the next segment.

Based on the client device 815b decision or receptions, the client device 815b decides what command to create and submit to the origin server 805.

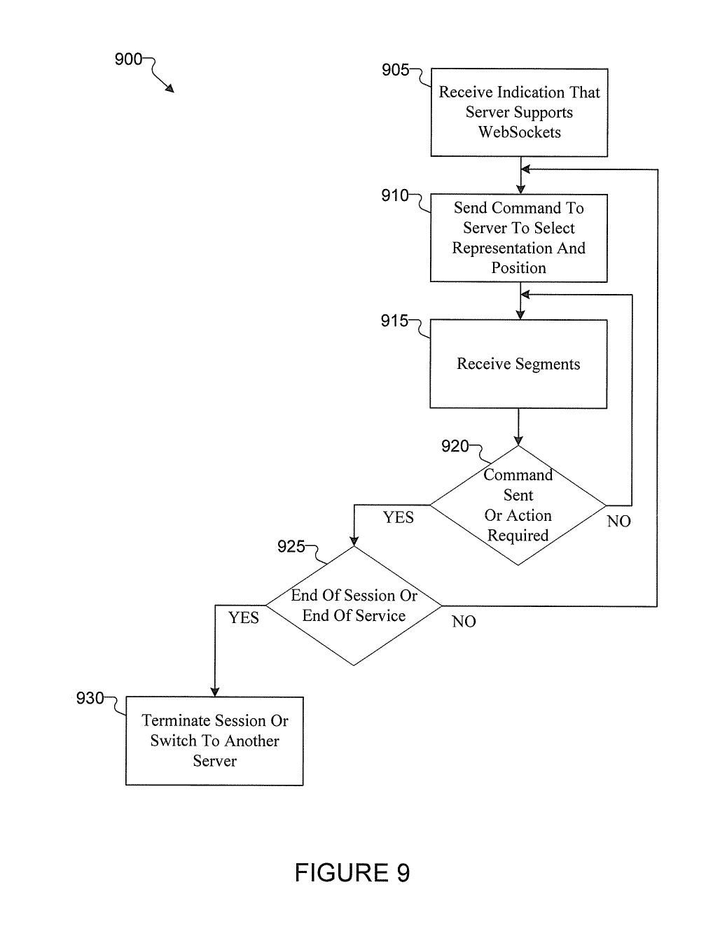

FIG. 9 illustrates an adaptive HTTP streaming process 900 utilizing WebSocket for a client device according to embodiments of the present disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a processing circuitry in, for example, a client device.

In block 905, the client device 300 receives an indication that the server 200 supports WebSockets. The server 200 indicates to the client device 300 that the server 200 is willing to upgrade to WebSockets to serve the media streaming session to the client device 300. After establishing the connection to the client device 300, the server 200 receives an initial request for a segment in block 910. The client device 300 sends a command, or request, to the server 200 to select representation and position. The server 200 encapsulates the segment in a frame and sends it. In block 915, the client device 300 receives the segments from the server 200. The server 200 continuously sends the following segments, such as by incrementing the segment number by one, until a new command is received or a decision is required by the client device 300. That is, in block 920, either a command is sent or an action is indicated as being required, such as when an MPD file update becomes available. If no action is required in block 920, the client device 300 continues to receive segments, such as by returning to block 915. If action is required in block 910, the client device 300 determines whether to terminate the session in block 925. When the client device 300 decides not to terminate the session in block 925, the client device 300 sends another command to the server to select representation and position in block 910. Alternatively, when the client device 300 decides to terminate the session in block 925, the client device 300 either terminates the session or switches to another server in block 930.

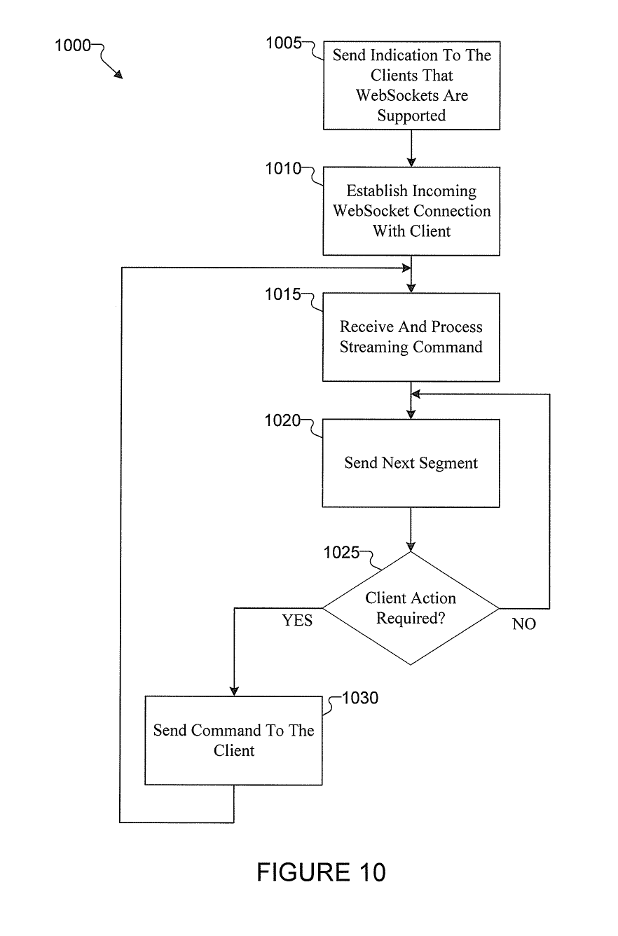

FIG. 10 illustrates an adaptive HTTP streaming process 1000 utilizing WebSocket for a server according to embodiments of the present disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a processing circuitry in, for example, a server.

In block 1005, the server 200 indicates to the client device 300 that the server 200 is willing to upgrade to WebSockets to serve the media streaming session to the client device 300. After the client device 300 receives an indication that the server 200 supports WebSockets, the server 200 establishes an incoming WebSocket connection with the client device 300 in block 1010. After establishing the connection to the client device 300, the server 200 receives an initial a command, or request for a segment in block 1015. That is, in response to the client device 300 sending a command, or request, to the server 200 to select representation and position, the server 200 processes the streaming command by encapsulating the segment in a frame and sending the segment to the client device 300. In block 1020, the server 200 sends the next segment to the client device 300. The server 200 continuously sends the following segments, such as by incrementing the segment number by one, until a new command is received or a decision is required by the client device 300. That is, in block 1025, the server 200 determines whether client action is required, such as when an MPD file update becomes available. If no action is required in block 1025, the server 200 continues to send segments, such as by returning to block 1020. If client device action is required in block 1025, in block 1030 the server 200 sends a command 200 to the client device 300 indicating the respective action, such as when an MPD file update becomes available.

In certain embodiments, adaptive HTTP streaming over WebSockets is realized as a sub-protocol of the WebSocket Protocol. The commands are defined as extension data in the WebSocket framing header. The following are possible commands from client device 300 to server 200:
(a) Request streaming of data from a particular Representation, possibly starting from an initial (init) segment and a particular segment number. The request can be the uniform resource locator (URL) of the first segment or the request can be the Presentation identifier, the Representation identifier, and the start segment number; and
(b) Request stop of streaming from server.
   The following are possible commands from server 200 to client device 300:
(a) Information about an MPD update;
(b) Identifier of the segment that is sent to the client; Each segment is framed separately and preceded by its URL or other identification;
(c) Request for client selection, such as because of a new Period. This command includes the current position in the timeline as well as other information why a client selection is requested; and
(d) Information about end of session or termination of the streaming session pre-maturely.

The segments and MPD updates are framed to enable client devices to identify each segment separately. The segments can be fragmented so that each movie fragment is sent as a unique fragment.

DASH over HTTP/2 and WebSocket

In order to make use of the full potential of the new protocols HTTP/2 and WebSocket, DASH applications must define a new sub-protocol that would be used on top of the upgraded connection. As HTTP/2 defines more functionality than WebSocket, because the sub-protocol in that case is meant to be equivalent to the HTTP 1.1 functionality, less work would need to be performed in the case of HTTP/2.

Certain embodiments of the present disclosure illustrate the functionality to make available to the DASH application:
(a) DASH client device is able to minimize amount of requests to server;
(b) DASH client device is able to do prompt rate adaptation;
(c) DASH client device is able to minimize delay, such as in the case of live streaming, where content is being generated on the fly; and
(d) DASH/Web server is able to prioritize the data from different Representations based on their importance to the playback.

Based on these targets, the new sub-protocols for HTTP/2 and WebSocket are defined.

DASH Sub-protocol for WebSocket

The sub-protocol is identified by the name “dash”. A client device wishing to use WebSocket for DASH streaming includes the keyword “dash” as part of the Sec-WebSocket-Protocol header field together with the protocol upgrade request.

After a successful upgrade of the protocol to WebSocket, the client and server exchanges DASH data frames (opcode ‘text’ or ‘binary’ or any ‘continuation’ frames thereof). The DASH frame format is defined as follows:

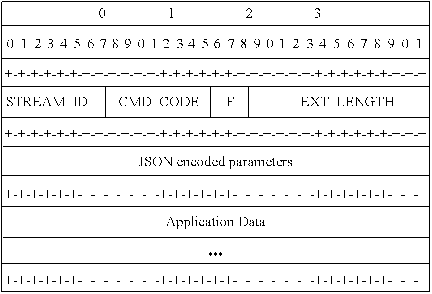

STREAM_ID: 8 bits is identifier of the current stream, which allows multiplexing multiple requests/responses over the same websocket connection.

CMD_CODE: 8 bits indicates the DASH command that is sent by this request/response. The following commands are currently defined:

| CMD_CODE | Description | Required Parameters |
|---|---|---|
| 0 | Get the MPD that is identified by | The URL of the MPD to be fetched |
| | the indicated URL. | and used as the basis for the current |
| | | DASH over Websocket session. |
| | | The json parameter is “url”. |
| 1 | MPD or MPD update (either | All HTTP entity headers for the |
| | pushed or sent as response to an | MPD resource. |
| | MPD request). | |
| 2 | Get single segment. | URL of the requested segment, |
| | | identified by the json parameter |
| | | “url”. |
| 3 | Get all segments of a particular | The identifier of the |
| | Representation starting with init | Representation as parameter |
| | segment and followed by media | “repid”. |
| | segments starting from a given | The segment number from |
| | segment or timestamp. | which to start streaming, |
| | | identified by the parameter |
| | | “segnum”. |
| | | Alternatively, the timestamp |
| | | from which to start streaming, |
| | | identified by “timestamp”. |
| | | Alternatively: |
| | | The segment URL template, that |
| | | contains a single template |
| | | parameter: segment number. |
| | | The json parameter is |
| | | “template”. |
| | | The start segment number from |
| | | which the streaming is to start, |
| | | identified by “segnum”. |
| 4 | Reply to a segment request, where | The entity body parameters |
| | the header contains all HTTP | encoded in json. |
| | headers in the first frame, followed | |
| | by the payload from the segment. If | |
| | the flags F field is set to “1xx”, then | |
| | the data in the response may be out | |
| | of order to support the low delay | |
| | case. The other 2 bits may be used | |
| | to indicate which frame contains | |
| | out of order data. | |
| 5 | Cancel the transmission of the | No parameters are required. |
| | current resource. This causes the | |
| | server to stop the transmission of | |
| | the current resource on the stream | |
| | identified by STREAM_ID. For | |
| | media segments, a server might | |
| | stop the transmission at a | |
| | reasonable point, e.g. at the end of a | |
| | movie fragment. | |
| 6 | Request to make a decision. This | The time instance or segment |
| | request is sent by the server to the | number after which autonomous |
| | client to inform the client that the | streaming by the server will stop. |
| | server cannot continue streaming as | |
| | it cannot make a decision on behalf | |
| | of the client. | |

F: 3 bits—This field provides a set of flags that are to be set and interpreted based on the command.

EXT_LENGTH: 13 bits—Provides the length in bytes of the extension data that precedes the application data.

DASH Sub-Protocol for HTTP/2

As discussed earlier, HTTP/2 can be considered a superset of WebSocket, providing a sub-protocol that is equivalent to the HTTP 1.1 protocol. Several of the functionality that is proposed for WebSocket DASH sub-protocol is already provided by the HTTP/2 protocol, such as support for multiple streams, cancelling the current transmission on a particular stream, and pushing data to the client using PUSH_PROMISE frames.

In order to remain backwards-compatible with HTTP/2, the DASH sub-protocol uses HEADERS frames to convey DASH-specific information and commands. A new header field is defined for this purpose that carries a set of comma separated name=value pairs. The DASH header field is called “Dash”. The following commands are introduced:

(a) Negotiate the support of DASH sub-protocol;

(b) Request continuous streaming of a particular Representation;

(c) Request client decision; and

(d) Communicate MPD updates

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A device comprising:
an interface configured to establish a communication connection with a server; and
processing circuitry configured to:
determine a capability of the server to support adaptive hypertext transfer protocol (HTTP) streaming over a WebSocket;
send commands to the server to perform streaming operations during the HTTP streaming; and
receive information from the server on the streaming session.

2. The device as set forth in claim 1, wherein the processing circuitry is configured to receive media segments until a triggering event occurs.

3. The device as set forth in claim 2, wherein the triggering event comprises a change in bandwidth measurement.

4. The device as set forth in claim 2, wherein the triggering event comprises an indication by the server that an update of a manifest file is available.

5. The device as set forth in claim 2, wherein the triggering event comprises a recommendation by the server for one or more representations.

6. The device as set forth in claim 2, wherein the triggering event comprises the processing circuitry receiving an indication for an action required by the processing circuitry.

7. The device as set forth in claim 2, wherein the triggering event comprises the processing circuitry receiving an end of stream or an end of service.

8. The device as set forth in claim 2, wherein in response to receiving one of: an end of stream or an end of service; the processing circuitry is configured to at least one of: terminate the HTTP streaming or switch to another server.

9. The device as set forth in claim 2, wherein in response to the triggering event, the processing circuitry is configured to send a command to the server.

10. The device as set forth in claim 2, wherein in response to the triggering event the processing circuitry is configured to one of:
select an alternative representation; or
performing trick mode operations.

11. A server comprising:
an interface configured to couple to at least one client device; and
processing circuitry configured to:
send an indication to the at least one client device that adaptive hypertext transfer protocol (HTTP) streaming over a WebSocket is supported; and
establish an incoming WebSocket connection with the at least one client device in response to a command received from the at least one client device to perform streaming operations during the HTTP streaming.

12. The server as set forth in claim 11, wherein the processing circuitry is configured to:
receive and process commands to perform streaming operations during the HTTP streaming; and
send a media segment to the at least one client device.

13. The server as set forth in claim 11, wherein the processing circuitry is configured to continue to send media segments until a triggering event occurs.

14. The server as set forth in claim 13, wherein the triggering event comprises one of:
a change in bandwidth measurement;
a determination that an update of a manifest file is available; or
a determination to send the at least one client device a recommendation by the server for one or more representations

15. The server as set forth in claim 13, wherein the triggering event comprises a command received from the at least one client device.

16. The server as set forth in claim 13, wherein the processing circuitry is configured to determine when additional action is required by the at least one client device and wherein the triggering event comprises the determination that additional action is required by the at least one client device.

17. The server as set forth in claim 13, wherein the processing circuitry is configured to send one of: an end of stream or an end of service.

18. The server as set forth in claim 11, wherein the processing circuitry is configured to send a request to the at least one client device to send a request for another segment.

19. A method for a client device, the method comprising:
establishing a communication connection with a server;
determining a capability of the server to support adaptive hypertext transfer protocol (HTTP) streaming over a WebSocket;
sending commands to the server to perform streaming operations during the HTTP streaming; and
receiving information from the server on the streaming session.

20. The method as set forth in claim 19, further comprising receiving media segments until a triggering event occurs, wherein the triggering event comprises one of:
a change in bandwidth measurement;
an indication by the server that an update of a manifest file is available;
a recommendation by the server for one or more representations;
receiving a request received from the server to send a request for a next segment;
receiving an indication for an action required by the client device;
receiving an end of stream or an end of service; or
receiving a request from the server to send a request for a next segment.

21. The method as set forth in claim 20, the method further comprising at least one of:
in response to receiving one of: an end of stream or an end of service; at least one of:
terminating the HTTP streaming, or
switching to another server; or
in response to the triggering event
sending a command to the server,
selecting, by the client device, an alternative representation, or
performing, by the client device, trick mode operations.
